(19) United States
(12) Patent Application Publication
(10) Pub. No.: US 2014/0339328 A1
(43) Pub. Date: Nov. 20, 2014

(54) HIGH VELOCITY OXY-LIQUID FLAME SPRAY GUN AND PROCESS FOR COATING THEREOF

(71) Applicant: Metallizing Equipment Co. Pvt. Ltd., Jodhpur (IN)

(72) Inventors: S. C. MODI, Jodhpur (IN); Ankur MODI, Jodhpur (IN)

(73) Assignee: Metallizing Equipment Co. Pvt. Ltd., Jodhpur (IN)

(21) Appl. No.: 14/281,280

(22) Filed: May 19, 2014

(30) Foreign Application Priority Data
May 20, 2013 (IN) 1501/DEL/2013

(51) Int. Cl. B05B 7/14; B05B 7/00

(52) U.S. Cl. CPC B05B 7/1486; B05B 7/0006
USPC 239/81

(57) ABSTRACT

Present invention relates to a high velocity oxy-liquid fuel spray gun, wherein said spray gun has a combustion chamber designed with outlet offset to the combustion chamber, a water inlet towards front side of the gun; and a narrow stabilizer arranged at 45 degree or 70 degree, inline of oxygen connector, fuel connector spark plug.

This application claims benefit of Serial No. 1501/DEL/2013, filed 20 May 2013 in India and which application is incorporated herein by reference. To the extent appropriate, a claim of priority is made to the above disclosed application.

### FIELD OF INVENTION

Present invention relates to a High Velocity Oxy-Liquid flame spray gun and a process for coating thereof.

### BACKGROUND OF THE INVENTION

Corrosion and wear resistant surfaces are needed for machine parts in many industries. The HVOF liquid fuel process supplies this protection by producing very thick, high-density coatings. For High Velocity Oxygen (liquid) Fuel (HVOF) spraying, we use an oxygen-kerosene mixture. We axially feed the coating material, in powdered form, through the gun, generally using nitrogen as a carrier gas. The fuel is thoroughly mixed with oxygen within the gun and the mixture is then ejected from a barrel and ignited inside the gun. The ignited gasses pass through convergent-divergent zone into a powder mixing area where it surround and uniformly heat the powdered spray material as it exits the gun and is propelled onto the work piece surface. High Velocity oxy-liquid flame (HVOF) spraying was developed by Browning and Witfield at the beginning of the 1980s. In this process, the fuel gases used combust under high pressure in a combustion chamber which is located downstream from an expansion barrel. In this way, high gas and particle velocities can be achieved with the aim or producing dense, low porosity coating with good bond strength.

The second generation of HVOF technology began with the development of the Top Gun by Erwin Huhne at the company UTP Schweibtechnik. Here, the gases are no longer diverted by 90 degree inside the spray gun. The further manufactures of second-generation system were Perkin Elmer Metco and Plasmatechnik.

The third generation of HVOF systems increased particle velocities even further and achieved even more dense thermal spray coating possible at that time without the need for thermal post treatment. Again, it was Jim Browning who launched the third generation. His system design forms the basis for Tafa JP 5000. In the following years, SulzerMetco, GTV and OSU Maschinenbau also brought their third generation equipment to market.

U.S. Pat. No. 5,520,334 discloses a method and apparatus are provided for operating a small diameter thermal spray gun to thermal spray a coating onto a substrate. A liquid fuel and regeneratively heated air are swirled together within a mixing chamber, passed through a restricter plate orifice, and then passed into the combustion chamber to atomize the liquid fuel and mix the liquid fuel with the regeneratively heated air. The liquid fuel is then burned within a combustion chamber of a small diameter thermal spray gun to generate a high energy flow stream, into which a coating material is injected. The combustion chamber includes an inner sleeve with cooling ports which pass cooling air laterally therethrough. A flow nozzle directs the high energy flow stream towards the substrate. The flow nozzle transfers a heat flow from a first portion of the high energy flow stream to a second portion of the high energy flow stream, and provides a thermal barrier to retain heat within the high energy flow stream. The small diameter thermal spray gun may be tuned for operating with a wide variety of coating materials by replacing the combustion chamber inner sleeve and the flow nozzle thermal transfer member with alternative members.

U.S. Pat. No. 5,285,967 discloses a high velocity, oxygen fuel (“HVOF”) thermal spray gun for spraying a melted powder composition of, for example, thermoplastic compounds, thermoplastic/metallic composites, or thermoplastic/ceramic composites onto a substrate to form a coating thereon. The gun includes an HVOF flame generator for providing an HVOF gas stream to a fluid cooled nozzle. A portion of the gas stream is diverted for preheating the powder, with the preheated powder being injected into the main gas stream at a downstream location within the nozzle. Forced air and vacuum sources are provided in a shroud circumscribing the nozzle for cooling the melted powder in flight before deposition onto the substrate.

None of the above cited document discloses a spray gun with pressure chamber having an offset design and a smaller nozzle. The spray gun of instant invention is able to coat inner surfaces having gap up to 150 mm of machine parts, and for inner cylindrical parts of diameter 150 mm. The water jacket in front side allows better cooling of the gun. The offset design of the pressure chamber allows high pressure within the chamber, thereby increasing the coating quality.

### SUMMARY OF THE INVENTION

The main object of the present invention to obtain a High Velocity Oxy-Liquid fuel (HVOLF) spray gun.

Another object of the present invention is to provide a High Velocity Oxy-Liquid fuel (HVOLF) spray gun for thermal spraying used for hard face coating. The spray gun of the instant invention is energy efficient and utilizes two third of oxygen when compared to liquid fuel spray guns existing in the prior art.

Yet another objective of the present invention is to provide a High Velocity Oxy-Liquid fuel spray gun which has a combustion chamber designed with outlet offset to the chamber.

Yet another objective of the present invention is to provide a High Velocity Oxy-Liquid fuel spray gun with water inlet towards front side of the gun.

Yet another objective of the present invention is to provide a High Velocity Oxy-Liquid fuel spray gun with a narrower barrel.

Yet another objective of the present Invention is to provide a High Velocity Oxy Liquid fuel (HVOLF) spray gun, having barrel angle at 45 degree or 70 degree.

Yet another objective of the present invention is to provide a High Velocity Oxy-Liquid fuel spray gun, wherein average particle size velocity is over 750 m/s for WC—Co or WC—Co—Cr.

Yet another objective of the present invention is to provide a High Velocity Oxy-Liquid flame spray gun where a temperature of up to 1900 degree C. can be obtained.

Yet another objective of the present invention is to provide a High Velocity Oxy-Liquid fuel spray gun wherein a high combustion chamber is achieved of up to 11 bars.

### DETAILED DESCRIPTION OF DRAWINGS

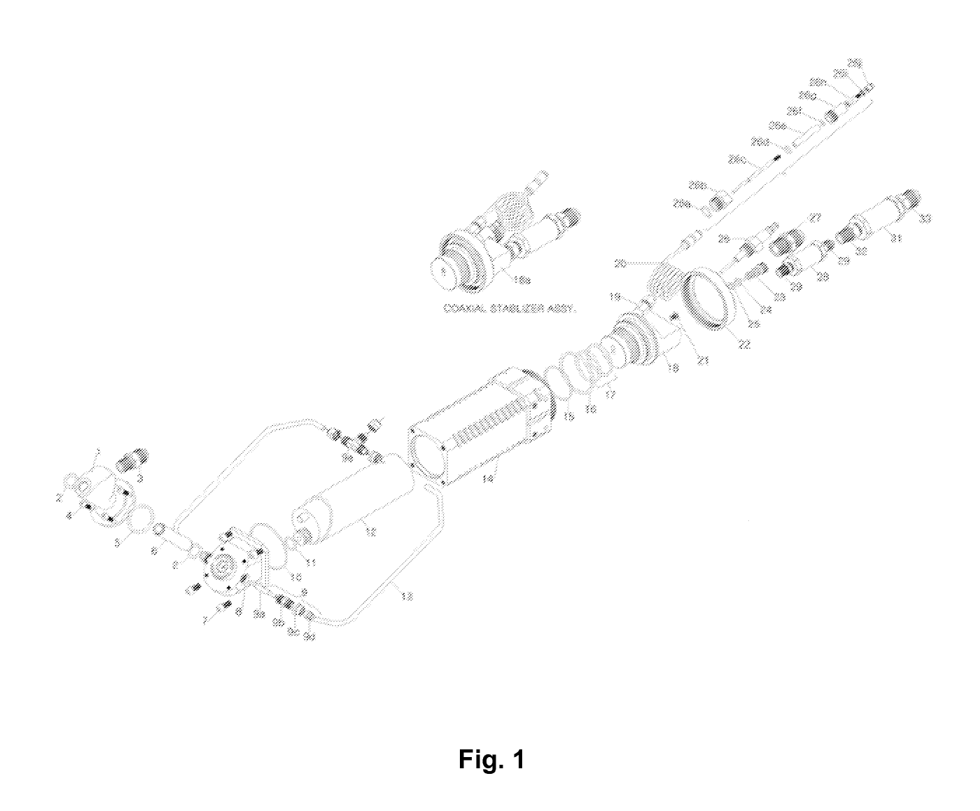

FIG. 1 shows exploded view of High velocity oxy liquid fuel spray gun of present invention.

### DETAILED DESCRIPTION OF INVENTION

The present invention relates to a High velocity oxy liquid fuel spray gun.

The present invention relates to a high velocity oxy liquid fuel gun which barrel is set at 45 or 70 degree to enable coating of inner surfaces especially where the approach by a standard gun is not possible, with a combustion chamber with offset design at barrel side. Higher combustion chamber pressures and resultant higher particle velocities produce coatings with neutral or compressive stresses.

The present invention relates to a HVOLF spray gun with a chamber designed so as to create a higher pressure. The spray gun has a smaller sized nozzle. The gun is able to coat on narrow area gap of 150 mm where conventional gun is not able to reach.

The spray gun of present invention develops combustion chamber pressures up to 11 bars compared to other HVOF systems, which normally operate at 2-8 bars. This pressure is translated into higher velocities, higher coating hardness's, higher coating densities and better overall coating integrity.

Fuel and oxygen mix and atomize after passing through orifices into the combustion chamber, creating stable, clean, uniform combustion. The combustion chamber pressure is monitored to ensure the proper combustion mode and constant pressure (particle velocity is directly proportional to chamber pressure). Chamber pressure monitoring also provides a cross-check on flow rates and is one of the most important factors influencing coating quality. The exit barrel of the combustion chamber is sized and shaped to create a supersonic over-expanded jet, to maintain a low pressure region where the powder is introduced; this jet is deflected by 45 degree at the start of a barrel. In the barrel, powder is uniformly mixed and accelerated along with the gas stream to the substrate.

Unlike other HVOF designs, which require closely controlled water temperatures to reproduce coating quality, the spray gun of instant invention, is not as sensitive to water temperature. This unique design permits use of inlet water temperatures from 50-70° F. (10-21° C.) without effect on gun performance or coating quality. The spray gun of present invention is a rugged, simple design that minimizes maintenance and maximizes production.

The velocity of particles is more and therefore, less time to get oxidation of powder. With the gun of present invention, one is able to coat inside the pipe up to 6 inches or 150 mm as compared to conventional gun they have spray distance up to 13 inches. The combustion chamber has an offset design as shown in FIG. 1. Higher combustion chamber pressures and the resultant higher particle velocities produce coatings with neutral or compressive stresses. Oxygen connector, fuel connector, combustion chamber pressure connector, and spark plug are mounted in line with the body so that the gun can easily move inside the narrow area.

FIG. 1 shows an exploded view of the High Velocity Oxy-Liquid fuel gun of the invention. The part list is provided as below:

PART LIST: No we are not required to mention size list.

| ITEM | |
|---|---|
| NO. | DESCRIPTION |
| 1 | Barrel holder |
| 2 | ‘O’ Ring for barrel |
| 3 | Water inlet connector |
| 4 | Socket head cap screw, |
| 5 | O-Ring for barrel holder |
| 6 | Barrel |
| 7 | socket head cap screw, |
| 8 | Interconnector |
| 9 | Feed tube assembly |
| 9a | Powder feed tube |
| 9b | Fitting powder port |
| 9c | Nut, |
| 9d | Ferrul plastic, |
| 9e | Powder feed splitter |
| 10 | O-Ring interconnector (big) |
| 11 | O-Ring combustion chamber |
| 12 | Combustion chamber |
| 13 | Steel tube, |
| 14 | Water jacket |
| 15 | O-Ring for combustion chamber to |
| | stabilizer spacer |
| 16 | O-Ring for stabilizer, rear |
| 17 | O-Ring for stabilizer, front |
| 18 | Coaxial stabilizer assembly |
| 18a | Coaxial stabilizer |
| 19 | Nipple, |
| 20 | Combustion pressure tube assy. |
| 21 | Screw, ground |
| 22 | Nut, stabilizer to water jacket |
| 23 | Coaxial tube with ‘o’ ring |
| 24 | O-ring coaxial tube, rear |
| 25 | O-ring coaxial tube, front |
| 26 | Spark plug assembly |
| 26a | o-ring spark plug seal |
| 26b | Spark plug base |
| 26c | Igniter electrode |
| 26d | o-ring insulator OD |
| 26e | Insulator spark plug |
| 26f | o-ring insulator rear |
| 26g | Spark plug body |
| 26h | Standoff |
| 26i | Internal tooth lock washer |
| 26j | Ignition terminal |
| 27 | Outlet connector |
| 28 | Check valve, fuel, |
| 29 | NIPPLE, fuel |
| 30 | Adapter, fuel line |
| 31 | Check valve, oxygen, |
| 32 | Nipple, oxygen |
| 33 | Adapter, oxygen line |

Interconnector 8 connects the combustion chamber 12 and the barrel 6. The coaxial stabilizer assembly 18 consists of a combustion pressure tube assay 20, a spark plug assembly 26, an outlet connector 27, a check valve for fuel 28 and a check valve for oxygen 31. Check valve 28 is provided with nipples 29 on its both sides and the check valve 31 is provided with a nipple 32 and an adaptor 33, the two check valves are connected by means of an adaptor 30 which connects the nipple 32 of check valve 31 and the nipple 29 of the check valve 28, the connected check valves are in turn connected to the coaxial stabilizer assembly 18 by the nipple 29 of the check valve 28. Combustion pressure tube assay 20 is connected to the coaxial stabilizer assembly 18 by a nipple 19. Coaxial stabilizer assembly 18 is connected to the combustion chamber 12 with outer water jacket 14 by means of a nut, stabilizer to water jacket 22, a coaxial tube 23, a screw ground 21 and ‘O’ rings 15, 16 and 17 for combustion chamber, for rear end of the stabilizer and for front end of the stabilizer respectively in between the combustion chamber to stabilizer spacer. The combustion chamber 12 with the connected coaxial stabilizer assembly 18 is connected to interconnector 8 on one side by means of an ‘O’ ring for combustion chamber 11 and an ‘O’ ring for interconnector 10, the interconnector being screwed to the outer water jacket 14 by means of four socket head cap screws 7. The interconnector 8 on the other side is connected to the barrel 6 and the barrel holder 1 by means of an ‘O’ ring for barrel 2 and an ‘O’ ring for barrel holder 5 respectively, the barrel holder 1 being screwed to the interconnector 8 by means of four socket cap screws 4. The interconnector 8 is further connected to a steel tube 13. The steel tube 13 consists of a feed tube assembly 9 and a powder feed splitter 9e. The feed tube assembly 9 consists of a powder feed tube 9a, a fitting powder port 9b, a nut tube 9c and a ferrul plastic tube 9d.

A spark plug assembly 26 is provided, which consists of a ‘O’ ring spark plug seal 26a, a spark plug base 26b, a ignite electrode 26c, an ‘O’ ring insulator OD 26d, an insulator spark plug 26e, an ‘O’ ring insulator rear 26f, a spark plug body 26g, a standoff 26h, an internal tooth lock washer 26i and an ignition terminal 26j.

A coaxial tube 23 consists of an ‘O’ ring 24 for rear end of the coaxial tube and an ‘O’ ring 25 for front end of the coaxial tube.

A characteristic feature of the spray gun of the present invention is that the oxygen connector, the fuel connector, the combustion chamber, the pressure connector, and the spark plug are mounted inline to the gun body so gun can easily move inside the narrow area.

Following are the advantages associated with the spray gun of present invention.
The oxygen connector, fuel connector, combustion chamber, pressure connector, and spark plug are mounted inline to the gun body so gun can easily move inside the narrow area.
The average particle size velocity of the metal achieved is over 750 m/s for WC—Co or WC—Co—Cr.
The temperature of 1900 degree C. can be obtained.
The combustion chamber up to 11 bars is achieved.
The oxygen flow rate is 62.3 m³/hr at 15-20.4 bars. System of instant invention consumes two third of the oxygen when compared to conventional spray guns.
The spray gun consumes less than 8.5 gph (32 Iph) unit same of kerosene when running.

Modifications and variations as would be apparent to a skilled addressee are deemed to be within the scope of the present invention. Various features of the invention have been particularly shown and described in connection with the exemplified embodiments of the invention, however, it must be understood that these particular arrangements merely illustrate and that the invention is not limited thereto. Accordingly the invention can include various modifications, which fall within the spirit and scope of the invention. It should be further understood that for the purpose of the specification the word “comprise” or “comprising” means “including but not limited to”.

We claim:

1. A high velocity oxy-liquid fuel spray gun, wherein said spray gun has a combustion chamber designed with outlet offset to the combustion chamber, a water inlet towards front side of the gun; and a narrow stabilizer arranged at 45 degree or 70 degree, inline of oxygen connector, fuel connector spark plug.

2. The spray gun as claimed in claim 1, wherein average particle size velocity is over 750 m/s for carbide powder.

3. The spray gun as claimed in claim 1, wherein the spray gun can reach the temperature of up to 1900 degree C. can be obtained.

4. The spray gun as claimed in claim 1, wherein a high pressure of up to 11 bars can be achieved.

5. The spray gun as claimed in claim 1, which can coat inside gap of 150 mm.
